(19) United States
(12) Patent Application Publication
(10) Pub. No.: US 2021/0323460 A1
(43) Pub. Date: Oct. 21, 2021

(54) Adaptable Container Assembly For Truck-mounted Containers To Increase Dumping Effectiveness

(71) Applicant: Drive Products Inc., Mississauga (CA)

(72) Inventor: Bhargav Khalasi, Mississauga (CA)

(21) Appl. No.: 17/230,894

(22) Filed: Apr. 14, 2021

(30) Foreign Application Priority Data
Apr. 15, 2020 (CA) 3077969

(51) Int. Cl. B60P 1/64

(52) U.S. Cl. CPC B60P 1/6463

(57) ABSTRACT

There is a container assembly for mounting a container on a truck, operable in a dumping mode or a grounding mode, comprising a base frame mounted on the flatbed, a dumping frame, connected to the base frame and removably attachable to a lower jib the lower jib, supporting the container, removably attachable to the dumping frame and pivotally or removably attachable to the base frame and a first power cylinder configured to rotate the lower jib when the first cylinder is extended and wherein in the dumping mode the lower jib is removably connected to the dumping frame, and whereby, the lower jib rotates to a dumping angle of greater than 45 degrees and wherein in the grounding mode the lower jib is removably and pivotally connected to the base frame, and whereby, the lower jib rotates to a dumping angle of less than 45 degrees.

### (1) FIELD OF THE INVENTION

This invention relates generally to truck-mounted containers and in particular to adaptable container assemblies to facilitate unloading contents and dumping of container contents.

### (2) BACKGROUND OF THE INVENTION

There exist many containers for trucks, motor vehicles and load-bearing vehicles, each offering various benefits and shortcomings. Notably, there is often a desire for a container that can be easily removed from the truck, without an expensive, unwieldy, or excessively large solution. Various solutions exist, including the solution as described in Canadian patent number 2,312,261 (the “261 Patent” and the “261 Solution”) and Canadian patent number 2,429,517 (the “517 Patent” and the “517 Solution”).

Although the 261 Solution and 517 Solution provide various improvements to removing containers, as described therein, the 261 Solution and 517 Solution also had some limitations in practice. In particular, while removal of the container was highly effective, the 261 Solution was of limited effectiveness in dumping the contents of the container as the angle possible between horizontal and the bottom of the container deck (“Dumping Angle”) could not exceed approximately 35 degrees, while keeping the container a suitable size and maintaining the stability and safety of the truck to which the container was attached.

The solutions were not able to both dump materials out of a container at an acceptably steep Dumping Angle, and while still enabling easy, such as rolling, removal of the container. There thus remains a need for a container that facilitates both operations for various trucks, motor vehicles and load-bearing vehicles.

### (3) SUMMARY OF THE INVENTION

There is disclosed a container assembly for mounting a container of contents, having a flat lower surface, to a flatbed of a load-bearing vehicle, whereby the container assembly can be adapted to operate in a dumping mode that facilitates dumping of the contents at a particular dumping angle, measured as the angle between the flatbed and the flat lower surface, and a grounding mode that facilitates lowering the container towards the ground from the flatbed, the container assembly comprising:

a base frame mounted on the flatbed, the base frame comprising a base frame front end proximate to a front of the vehicle, and a base frame back end proximate to a back of the vehicle;

a dumping frame, comprising a dumping frame rear portion pivotally connected to the base frame back end at a dumping frame connection location, and comprising a dumping frame front portion removably attachable to a lower jib;

the lower jib, comprising a container carrier assembly, and a lower jib rear portion removably attachable to the dumping frame front portion and pivotally and removably attachable to the base frame at a lower jib base frame connection location wherein the lower jib is adapted to swing upwardly about the dumping frame pivot point or the lower jib base frame connection location between a lowered position in which the lower jib extends forwardly and lies substantially parallel with the flatbed and a dumping position in which the lower jib rotates generally upwardly from the first location;

a first power cylinder, connected to the base frame front end and the lower jib, configured to rotate the lower jib when the first cylinder is extended; and

wherein the dumping mode is characterized by the lower jib being removably connected to the dumping frame, and whereby, upon extension of the first cylinder the lower jib rotates about the dumping frame connection location into a dumping position with a dumping angle of greater than 45 degrees; and wherein the grounding mode is characterized by the lower jib being removably and pivotally connected to the base frame, and whereby, upon extension of a first cylinder the lower jib rotates about the lower jib base frame connection location into a dumping position with a dumping angle of less than 45 degrees.

The container carrier assembly may further comprise:

a container, pivotally attached to the upper jib;

the upper jib, pivotally connected at an upper jib rear end to a pivot location on the lower jib, and comprising at an upper jib forward end configured to engage the container such that the upper jib can pivot about the pivot location to lift the bottom deck of the container away from the lower jib; and a second power cylinder for causing the upper jib to pivot about the intermediate location.

There is also a container assembly for rotating a container of contents around a dumping point into a first dumping angle, or around a grounding pivot point into a second dumping angle, the container assembly comprising:

a base frame installed on a flatbed;

a lower jib assembly, configured to be removably pivotally connectable to one of a first pivot point or a second pivot point;

a first power cylinder, connected to the base frame at a base frame front end and the lower jib, configured to rotate the lower jib when the first cylinder is extended; and

wherein the dumping pivot point is at a rear end of the base frame, and whereby, upon extension of the first cylinder the lower jib rotates about the dumping pivot point into a dumping position with a first dumping angle of greater than 45 degrees; and wherein the grounding pivot point is at an intermediate location on the base frame, and whereby, upon extension of the first cylinder the lower jib rotates about the grounding pivot point into a dumping position with a second dumping angle of less than 45 degrees.

To be removably pivotally connected to the dumping pivot point the lower jib assembly may be connected to a front end of a dumping frame and the dumping frame may be pivotally connected to the base frame at the umping pivot point.

The lower jib assembly may further comprise a lower jib, an upper jib, a second power cylinder and a container.

The first dumping angle may be 54 degrees and the second dumping angle may be 34 degrees.

There is further a motor vehicle having any of the container assemblies referenced herein.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### (4) BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of an enhanced dumping angle container assembly, for incorporation with a load-bearing vehicle, in a dumping mode, according to an aspect of the present invention.

FIG. 2 is a side view of an enhanced dumping angle container assembly, for incorporation with a load-bearing vehicle, in a dumping mode, according to an aspect of the present invention.

FIG. 3 is a side view of an enhanced dumping angle container assembly, for incorporation with a load-bearing vehicle, in a grounding mode, according to an aspect of the present invention.

FIG. 4 is a side view of an enhanced dumping angle container assembly, for incorporation with a load-bearing vehicle, in a grounding mode, according to an aspect of the present invention.

### (5) DETAILED DESCRIPTION OF THE INVENTION

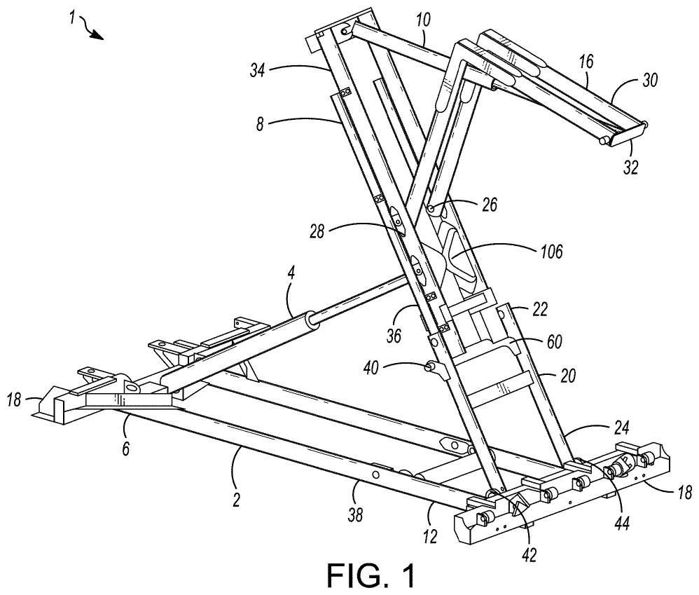

FIG. 1 shows a perspective view of an enhanced dumping angle container assembly for incorporation with a motor vehicle (also referred to as a truck or load-bearing vehicle) incorporating an enhanced dumping angle container assembly, in a dumping mode, according to an aspect of the present invention.

Container assembly 1 may be similar in many respects to the container assembly as described in Canadian patent number 2,312,261—referred to therein, and herein, as the mechanism or the 261 Solution as defined herein and/or similar in many respects to the container assembly as described in Canadian patent number 2,429,517—referred to therein, and herein, as the carriage lifting apparatus or the 517 Solution as defined herein. Such solutions, and the exact components thereof, are not exhaustively shown, numbered, or listed herein but may still be part of container assembly 1, subject to the changes described herein relating to aspects of the present invention.

As generally shown in FIG. 1, container assembly 1 comprises the following components:

Forward or base frame 2. Base frame 2 may be connected to a flatbed portion of a load-bearing vehicle (such as a truck) at connection locations 18, which may be at the forward and rear of the flatbed. Base frame 2 may have a forward portion 6, which may be that portion closer to the cab of the truck, and a rear portion 12, which may be that portion closer to the cab of the truck. Base frame may be desired to support the components of container assembly 1 but may be in different shapes or configurations.

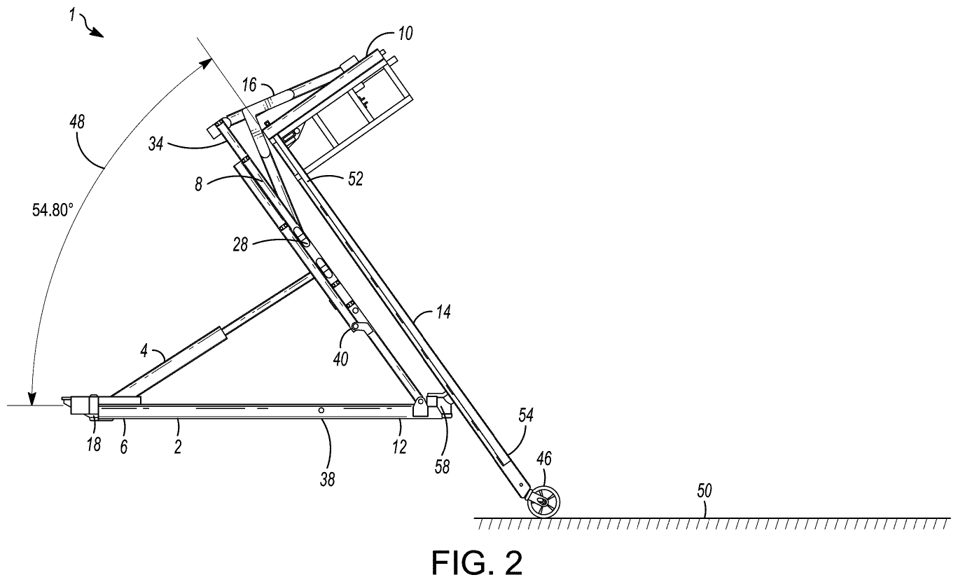

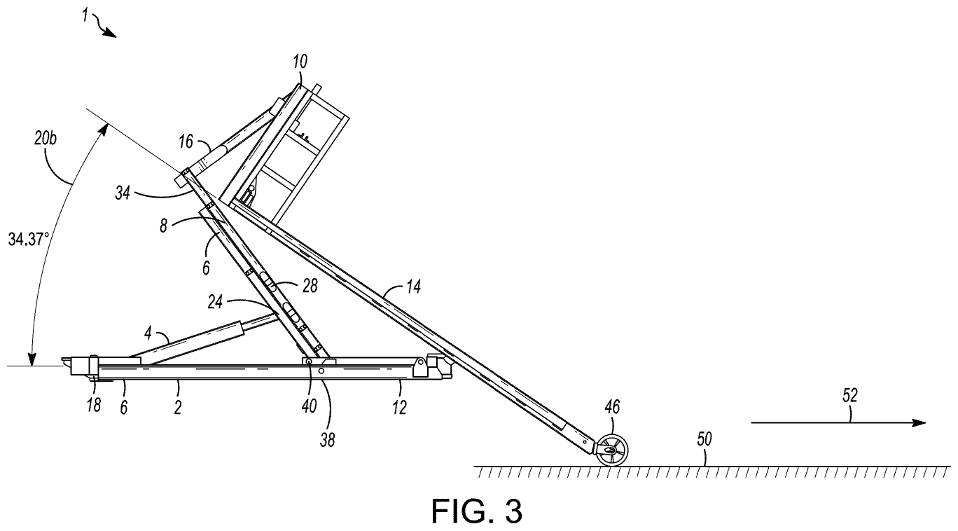

Rear or dumping frame 20. Rear frame 20, comprises a dumping frame rear portion 24 that may be pivotally connected to base frame 2, or directly to the flatbed, at pivot locations 44 (which may be referred to as dumping frame connection location or dumping pivot point). Rear frame 20 further comprises a dumping frame forward portion 22 that may be either connected to lower jib 8, via one or more rear frame locks 40, 60 (as seen in FIGS. 1 and 2—in a “connected mode”, which may be for dumping mode) or may not be connected to lower jib 8 (as seen in FIG. 3—in a “disconnected mode”, which may be for grounding mode). When in a connected mode rear frame 20 and lower jib 8 move together, as described herein. When in a disconnected mode rear frame 20 does not move with lower jib 8, and in fact may remain disposed horizontally and within base frame 2.

Lower jib 8. Lower jib 8 comprises a lower jib forward end 34 and a lower jib rearward end 36. Forward end 34 may rest near forward portion 6 of base frame 2 when container assembly is not in grounding mode or dumping mode (for example when the truck is in transit), which may be a lowered position.

Rearward end 36 may be connected in one of two ways. When in dumping operation or mode, rearward end 36 may be removably connected to rear frame 20 via rear frame locks 40. As described, lower jib 8 would then move with rear frame 20 and pivot around location 18, where rear frame 20 is pivotally connected to base frame 2 or flatbed. Such is shown in FIGS. 1 and 2. When in grounding operation or mode, rearward end 36 may be connected to base frame 2 or to flatbed at the lower jib base frame connection location 38—either of which may be some distance along base from in moving from forward portion 6 to rear portion 12, but not as close to the rear portion of 12 as pivot location 18. Switching between dumping mode and grounding mode may be via switching the pivot location of rearward end 18. Switching modes may be done automatically or manually, and may use hydraulics or a simple mechanical pin.

The lower jib 8 can pivot, and thus rotate, via activation of cylinder 4, pivoting about pivot location 20 or location 18, depending on the mode of operation. In either mode pivoting is clockwise in FIGS. 1-4 when cylinder 4 is extending and counterclockwise when cylinder 4 is retracting. When lower jib 8 is rotated by cylinder 4 it may move from a lowered position to a dumping position (whether or not dumping actually happens, for example, and whether or not in dumping mode or grounding mode).

Lower jib 8 may be part of a lower jib assembly, which may further comprise one or more power cylinders, upper jib 16 and container 14.

Cylinder 4. Cylinder 4, or power cylinder, may be any suitable linear actuator, such as air or hydraulic, and comprises a forward end which is pivotally mounted to the flat bed or base frame 2 at a pivot location. The rearward end of the air or hydraulic cylinder (the end of the piston thereof) is pivotally connected to the lower jib 8 at a pivot location 106 which may be located along approximately one-quarter of the distance between the rearward end 36 and a forward end 34.

Upper jib 16. Upper jib 16 has a rearward end 26 which is pivotally mounted at a pivot location 28 to lower jib 8, the pivot location 28 being approximately midway of the ends of the lower jib 8 and closer to the forward end 34 than rear portion 24 is, when in connected mode, and may be closer to the forward end 34 than rearward end 36. Upper jib 16 further has forward end 30 which is pivotally connected to the upper end of a second air/hydraulic cylinder 10, at a laterally extending pivot member at location 32. The bottom end of the further air/hydraulic cylinder 10 may be pivotally connected to the forward end 34 of the lower jib 8.

It will thus be understood that, assuming the air/hydraulic cylinder 10 remains inactive and does not change its length, the “triangle” formed by the lower jib 8, the upper jib 16 and cylinder 10 will remain static and will rotate about the pivot location (either location 42, 44, the dumping pivot point 58, or 38, the grounding pivot point) along with lower jib 8.

As cylinder 10 extends its effect will be that of rotating the upper jib 16 about the pivot location 28, in the clockwise direction as pictured in FIG. 2. This will cause upper jib 16 to rotate with respect to the lower jib 8.

Upper jib 16 and cylinder 10 may be considered a container carrier assembly 52, to which the container 14 may be connected and may be moved by activation of cylinder 10, as described herein). Container may be considered part of the container carrier assembly or referred to separately. A carrier assembly may substantially any assembly that attaches container 14, directly or indirectly, to container assembly 1 and lower jib 8 in particular), such that container 14 moves as lower jib 8 rotates. When inactive (in a lowered position, with limited or no extension by cylinder 10) carrier assembly may keep a lower surface of container 14 substantially parallel to lower jib 8. When activated (in an extended position, with more extension by cylinder 10) carrier assembly may pivotally change from being parallel.

Container 14. Container 14 may be a structure on which contents can be placed, or in which contents can be placed. Container 14 may at least have a bottom interior surface and a bottom exterior surface 54. Container 14 may be a box with any number of sides. Container may be attached, such as pivotally attached, to upper jib 16, such as described in the 261 Solution or the 517 Solution. Container 14 may have wheels 46 attached thereto, that may roll when container 14 is in contact with ground 50.

Dumping Mode

Dumping mode operation is when the contents of container 14 are to be dumped out, by tilting container 14. Dumping Angle 48 (the angle between flatbed or base frame 2, or horizontal ideally, and container 14) may desirably be steep in dumping mode, to encourage the contents to come out.

In operation in dumping mode, as shown in FIGS. 1-2, lower jib 8 is connected to rear frame 20. Cylinder 4 may be extended, resulting in lower jib 8 (and as a result upper jib, and container 14) rotating clockwise along the path 20a that defines the Dumping Angle. Cylinder 4 may be extended until wheels 46 are just touching, or proximate to but not touching, ground 50, though it may be preferable for dumping to occur when wheels 46 are above the ground by some distance.

Of course lowering may be performed in dumping mode, but may not be ideal given the increased Dumping Angle, and it may be preferable for wheels 46 to not touch the ground 50 when dumping. In some embodiments container 14 or the body of what is being dumped may be somewhat shorter as well, making it less likely that wheels 46 touch ground 50.

As shown in FIG. 2, and in contrast with FIG. 3, the Dumping Angle may exceed 45 degrees, and in fact may reach approximately 55 degrees, based on the geometry of container 14, end of the flatbed, the lower jib 8 and upper jib, and importantly, that the lower jib pivot point has moved to the rear of base frame 2. Various Dumping Angles, for example between 45 and 55 degrees, are of course possible based on the dimensions of elements of container assembly 1 and pivot locations in dumping mode.

At a particular Dumping Angle, wheels 46 of container 14 engage the ground 50, as shown in FIG. 2. At that point further extension of cylinder 4 would continue to rotate lower jib clockwise and closer to a vertical position but would not increase the dumping angle as wheels 46 would roll in the direction defined by arrow 62 (as container assembly, connected to the motor vehicle, would not move). Of course it may be preferable for the cylinders to not extend and cause rotation such that wheels 46 engage ground 50 when in dumping mode.

Cylinder 10 may be extended or may remain unextended, or retracted, when in dumping mode. For example, in the dumping mode or cycle, cylinder 10 may have a stroke length of approximately 10″ to unlock the body from rear locks (not shown) and may not further be used.

When in dumping mode lower jib 8 may be rotated through approximately 135 degrees, and upper jib 16 may rotate through approximately 45 degrees. Of course in dumping mode it may not be desired, or allowed, to rotate either jib more than is required to achieve a desired dumping angle.

Grounding Mode

Grounding mode operation is when container 14 is not necessarily to be dumped, but is to be lowered to, or near, ground 50. This typically involves lowering container 14 such that wheels 46 on container 14 engage the ground. This may be so that container 14 can be removed from container assembly 1, or simply so container 14 may be used (emptied, filled, or otherwise accessed) when container 14 is on or near the ground (meaning that it might be flat as well).

Of course dumping may be performed in grounding mode, but may not be ideal given the reduced Dumping Angle.

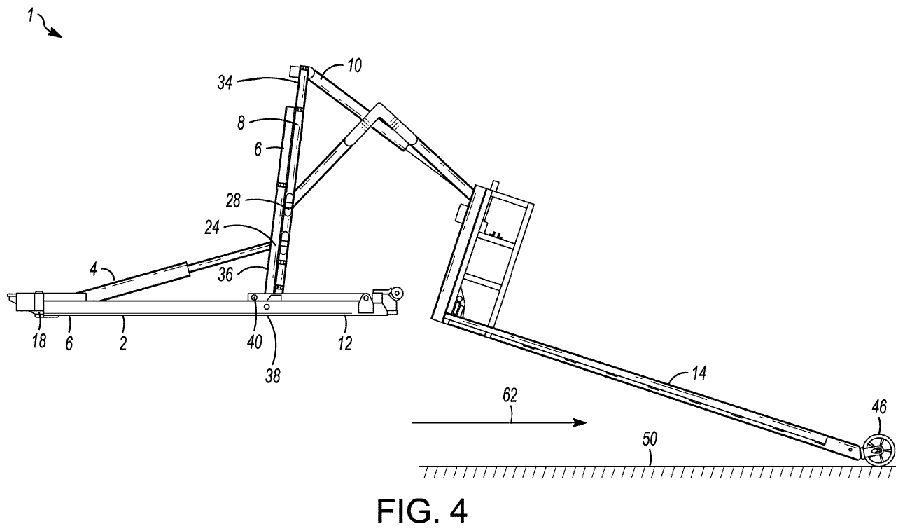

In grounding mode, as shown in FIGS. 3-4, lower jib 8 is connected to base frame 2 or flatbed and rotates clockwise along path 20b that defines the Dumping Angle that would occur if dumping were done in grounding mode. The Dumping Angle may be limited to approximately 34 degrees, based on the geometry of container 14, end of the flatbed, the lower jib 8 and upper jib, before wheels 46 touch the ground 50, as in FIG. 3. Various Dumping Angles, for example below 34 degrees but above 20 degrees, are of course possible based on the dimensions of elements of container assembly 1 and pivot locations in the ground mode.

After wheels 46 touch ground 50 further extension of either cylinder 4 or second cylinder 10 may result in wheels 46 rolling in the direction of arrow 62 in FIG. 4, meaning container 14 is closer to parallel to ground 50 and therefore having a reduced Dumping Angle.

As shown in FIG. 4, lower jib 8 may be rotated through approximately 135 degrees, and upper jib 16 may rotate through approximately 45 degrees to accomplish placing container 14 on ground 50. Of course the amount, or degrees, of rotation will vary somewhat (for example plus/minus 10-20 degrees) based on the lengths of the elements herein, and loading conditions (such as what the load is, where it is located, how long it is, and the like).

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1. A container assembly for mounting a container of contents, having a flat lower surface, to a flatbed of a load-bearing vehicle, whereby the container assembly is adapted to operate in a dumping mode that facilitates dumping of the contents at a particular dumping angle, measured as the angle between the flatbed and the flat lower surface, and a grounding mode that facilitates lowering the container towards the ground from the flatbed, the container assembly comprising:
a base frame mounted on the flatbed, the base frame comprising a base frame front end proximate to a front of the vehicle, and a base frame back end proximate to a back of the vehicle;
a dumping frame, comprising a dumping frame rear portion pivotally connected to the base frame back end at a dumping frame connection location, and comprising a dumping frame front portion removably attachable to a lower jib via one or more rear frame locks which are disengaged when the dumping frame front portion is disconnected from the lower jib;
the lower jib, comprising a container carrier assembly, and a lower jib rear portion removably attachable to the dumping frame front portion and pivotally and removably attachable to the base frame at a lower jib base frame connection location wherein the lower jib is adapted to swing upwardly about the dumping frame pivot point or the lower jib base frame connection location between a lowered position in which the lower jib extends forwardly and lies substantially parallel with the flatbed and a dumping position in which the lower jib rotates generally upwardly from a first location;
a first power cylinder, connected to the base frame front end and the lower jib, configured to rotate the lower jib when the first power cylinder is extended; and
wherein the dumping mode is characterized by the lower jib being removably connected to the dumping frame via said one or more rear frame locks, and whereby, upon extension of the first power cylinder the lower jib rotates about the dumping frame connection location into a dumping position with a dumping angle of greater than 45 degrees; and
wherein the grounding mode is characterized by the lower jib being removably and pivotally connected to the base frame, and whereby, upon extension of a first cylinder the lower jib rotates about the lower jib base frame connection location into a dumping position with a dumping angle of less than 45 degrees and further including,
a container, pivotally attached to an upper jib;
the upper jib, pivotally connected at an upper jib rear end to a pivot location on the lower jib, and comprising at an upper jib forward end configured to engage the container such that the upper jib pivots about the pivot location to lift a bottom deck of the container of contents away from the lower jib; and
a second power cylinder for causing the upper jib to pivot about an intermediate location
and wherein the lower jib, the upper jib and the second power cylinder form a static triangle that rotates about the pivot location.

2. The container assembly of claim 1 wherein, to be removably pivotally connected to the dumping pivot point the lower jib assembly is connected to a front end of a dumping frame and the dumping frame is pivotally connected to the base frame at the second pivot point.

3. The container assembly of claim 1 wherein the lower jib assembly further comprises a lower jib, an upper jib, a second power cylinder and the container of contents.

4. The container assembly of claim 1 wherein the first dumping angle is 54 degrees and the second dumping angle is 34 degrees.

5. The container assembly of claim 1, wherein the upper jib has a lateral extending pivot member at its distal and to provide overall rigidity to arms of the upper jib.

6. (canceled)
